(19) United States
(12) Patent Application Publication
(10) Pub. No.: US 2025/0121477 A1
(43) Pub. Date: Apr. 17, 2025

(54) Centering feature in low profile clamp

(71) Applicant: Oetiker Schweiz AG, Horgen (CH)

(72) Inventors: Edoardo ROSSI, Horgen (CH); Christoph SCHNEEBERGER, Horgen (CH); Steffen Richter, Horgen (CH); Patrick MÜLLER, Horgen (CH); Bianca GRIMALDI, Horgen (CH)

(73) Assignee: Oetiker Schweiz AG, Horgen (CH)

(21) Appl. No.: 18/905,231

(22) Filed: Oct. 3, 2024

(30) Foreign Application Priority Data
Oct. 12, 2023 (DE) 102023127958.0

(51) Int. Cl. B25B 5/16; B25B 5/14

(52) U.S. Cl. CPC B25B 5/166; B25B 5/147

(57) ABSTRACT

The present invention relates to a low profile clamp in which one or both contact surfaces of upper and lower circumferential end portions have a non-flat and preferably complementary cross-sectional shape in the width direction of the band material. Thereby, sliding contact of the upper contact surface on the lower contact surface provides a self-centering effect of the band end portions during a band closing action.

### BACKGROUND OF THE INVENTION

### 1. Field of the Invention

The present invention relates to a clamp made from a flat metal band or strip formed into a loop to be fastened around an object of substantially circular cross-section such as a hose, pipe or boot. In particular, the present invention relates to so-called “low profile clamps”, i.e., clamps whose hook elements project only to a limited extent radially outwards leading to a relatively small overall radial clamp profile. Further, the present invention relates particularly to so-called stepless clamps, i.e., clamps having in their closed condition almost no uneven portions or steps at the inner surface. U.S. Pat. No. 5,669,113A and WO 2009/152832 A1 provide examples of such stepless clamps. The clamps have an outwardly projecting ear which can be crimped by a crimping tool to firmly tighten the clamp around the object to be fastened.

### 2. Description of the Related Art

US 2009/0313792 A1 discloses a conventional clamp having a connecting hook (fastening stud) projecting radially outwards in the vicinity of the first end of the strip and a tensioning hook (fastening ear) projecting radially outwards in the vicinity of the second end of the strip and provided with an aperture into which a free end edge portion of the connecting hook can be inserted for the purposes of fastening and of tightening the clamp while the fastening ear fits over a foot portion of the connecting hook.

WO 2018/082819 A1 gives another example of such a conventional clamp having closing hooks in form of a connecting hook and two tensioning hooks for tightening the clamp around the object to be fastened by a tightening tool such as pliers.

A disadvantage encountered with those conventional low profile clamps resides in that axial misalignment may occur during the closing action, in particular the last stage of the closing action when the highest closing forces are applied. This may lead to unreliable engagement of the upper band end portion with the lower band end portion. As a result, this weakens the impact resistance of the clamp, i.e., it entails the risk of disassembling of the hook elements by impact of an outer force.

### BRIEF SUMMARY OF THE INVENTION

An object of the present invention is to improve the correct alignment of the connecting elements during the closing action. The clamp should reach the closed state properly and safely by ensuring that the tensioning hook is circumferentially parallel with the connecting hook.

This object is achieved by the clamp defined in claim 1. The other claims relate to preferred embodiments.

According to the present invention, a centering feature at the upper band end prevents band end misalignment during closure of low profile clamps. In particular, the centering feature resides in a contact surface with a non-flat cross section provided at the upper band end arranged for sliding contact with a contact surface at the lower band end during the band closing action, i.e., when the clamp is brought into the closed condition by pulling the first and second tensioning hooks circumferentially towards each other. The proposed solution enables to position the upper band centrally with respect to the connecting hook (also known as load retaining hook) on the lower band.

Preferably, the contact surface with non-flat cross section is provided on radially opposing parts of both the upper band end and the lower band end and, more preferably, such that the cross-sectional shapes of the two contact surfaces are complementary to each other. Thereby, the radially opposing parts at both band ends contribute their share to the desired centering. Both contact surfaces are preferably provided only in a central part of the clamp band in the width direction.

In a preferred example, the cross section of the contact surface has a round shape, in particular the shape of a ring segment. In other words, the contact surface forms an arc when seen in the axial direction in which the band width is measured. Such cross-sectional shapes have turned out to be most efficient to obtain a smooth and evenly distributed centering effect across the complete width of the contact surface.

According to the proposed solution, the upper (second) contact surface has a rounded shape on the inward side, which approximately matches the outer (first) surface of the load retaining (or connecting) hook. This permits the band end, during closure of the clamp, to be guided in a centered position relative to the load retaining hook. In the proposed shape (other shapes leading to the same function are included) the rounded surface allows to centralize the band end during closure of the clamp by a guided sliding on the load retaining hook outer surface. This prevents unwanted misaligned closures (not centered engagement of the band end with the load retaining hook feature) of the clamp. Different non-flat cross-sectional shapes (not only circular shape, but others) may be used, preferably when the lower band end surface matches the upper load retaining hook surface.

In the most preferred example, the non-flat cross section of the contact surface extends up to the area immediately adjacent to the aperture side of the tensioning hook at the upper band end. In other words, the centering feature is provided right before the engagement surface. Thereby, the guiding effect takes place until the end of the closing stroke, i.e., at the time at which the closing force acting on the band is at a maximum and the risk of misalignment is highest.

In another, preferable example, the upper end portion of the band has a free end which is radially raised, and the contact surface is provided in a region which is circumferentially between the aperture of the tensioning hook and the radially raised free end. This further improves the smoothness of the interaction of the free end with the closing hook at the start of the closing action. To obtain a seamless continuation of the closing action, the regions immediately adjacent to the contact surface in the width direction are at the same radial height as the raised free end and circumferentially extend at this height up to the raised free end.

In a further optimized embodiment of the invention the connecting hook is provided with additional guiding elements. Beside the central ramp portion with the claimed lower contact surface, the connecting hook may have one or more guiding elements adjacent to the central ramp in the width direction. Those guiding elements allow for centering the upper end portion during the closing action and may preferably form grooves towards the ramp portion which grooves have funnel-like shape. Such a shape of the connecting (or load retaining) hook further improves the centered guiding of the band end during the closing stroke.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a side view of a conventional (i.e., prior art) low profile clamp in a rounded and preassembled state;

FIG. 2 is a top view of the conventional low profile clamp of FIG. 1 in a flat (unrounded) state;

FIG. 3A is an enlarged top view of region X at the second end portion of the clamp of FIG. 2;

FIG. 3B is a sectional view of region X along line B-B in FIG. 3A;

FIG. 4 is a sectional view of overlapping first and second band end portions of a clamp according to an embodiment of the present invention during a clamp closing action;

FIG. 5A is a cross-sectional view along line A-A of FIG. 4;

FIG. 5B shows two enlarged views of the upper band part in FIG. 5A;

FIG. 6A is a perspective view of the connecting hook according to a second embodiment of the present invention;

FIG. 6B shows a side view of the connecting hook of FIG. 6A;

FIG. 6C shows a rear side view of the connecting hook of FIG. 6A;

FIG. 7 is a side view of the low profile clamp according to the first embodiment in a rounded and preassembled state; and

FIG. 8 is a top view of the low profile clamp of FIG. 7 in a flat (unrounded) state.

### DETAILED DESCRIPTION OF THE INVENTION

In the present specification, the terms “radial”, “axial” and “circumferential” refer to an overall geometrical form of the clamp which, in its closed state, is generally a ring having a certain radius and circumference. The clamp is designed for embracing a pipe, hose or boot which extends substantially in the axial direction which corresponds to the width direction of the band material.

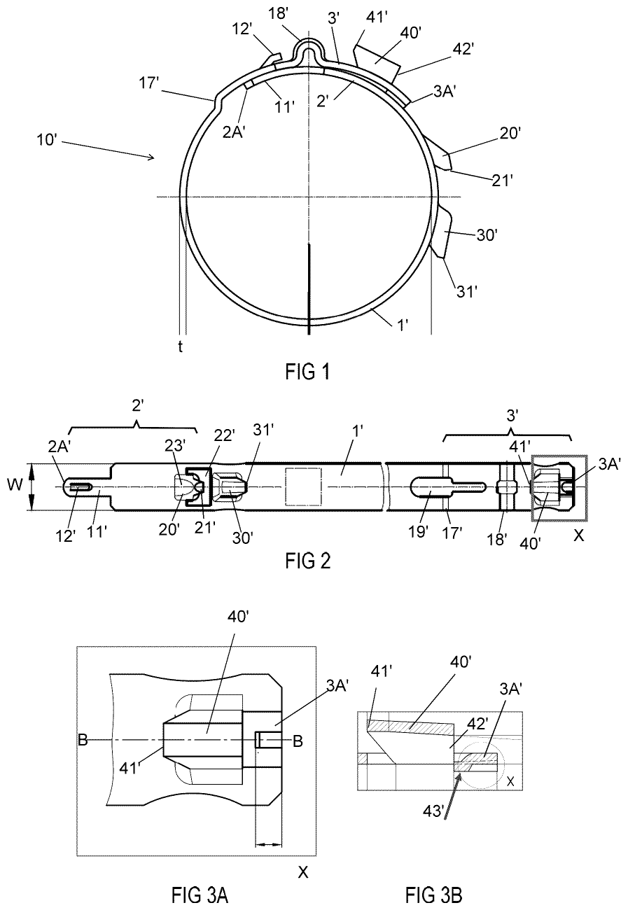

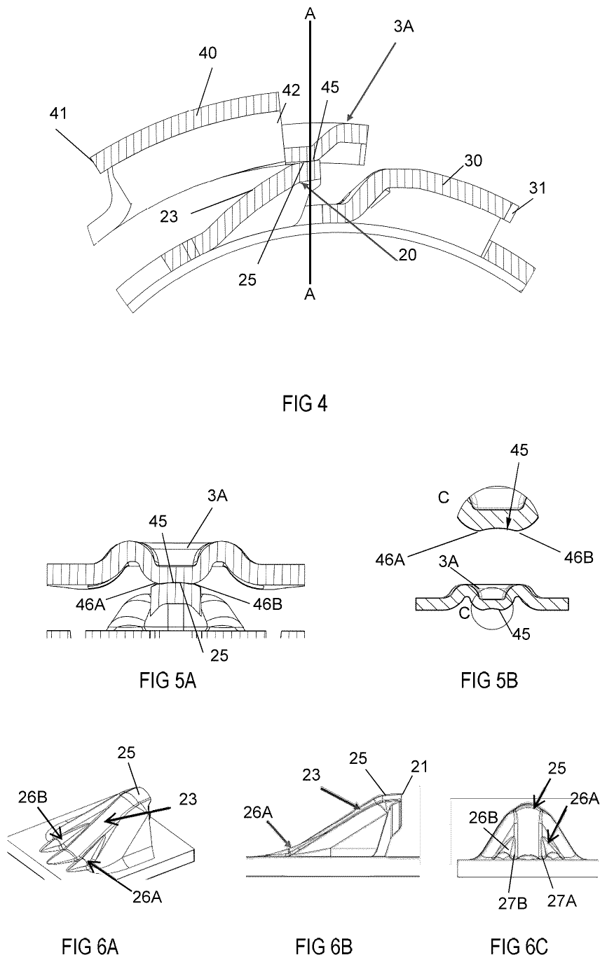

FIGS. 1 to 3 show a low profile clamp of a conventional design known in the prior art. Apart from the band shape at the end region denoted as X in FIG. 2, the individual band elements and their functionality are similar to those shown in the first and second embodiments of the present invention depicted in FIGS. 4 to 8. The elements shown in the prior art design of FIGS. 1 to 3 are marked with a prime symbol (′) and the elements with corresponding functionality in the embodiments of the invention have no such prime symbol.

FIG. 1 is a side view of the clamp 10′ in a rounded and preassembled state. FIG. 2 shows the same clamp 10′ in a flat (unrounded) state having the width W, and Figures FIGS. 3A and 3B show a top view and a sectional view of region X of FIG. 2.

The clamp 10′ is made from a flat metal band or strip l′ having the thickness t by various cutting and deforming or embossing steps which are generally known in the art. The tip end 2A′ of the first circumferential end portion 2′ has a reduced width and forms a tongue portion 11′ adapted to be received in a tongue channel 19′ at the inside of the second end portion 3′ of the band 1′. At the middle of the tongue channel 19′ there is a radial step 17′. The height of the step 17′ corresponds to the thickness t of the flat band material 1′. Therefore, the clamp 10′ in its closed state provides a substantially stepless inner surface facing the object to be fastened.

The tongue portion 11′ has a preassembling hook 12′ which protrudes radially outwards and is adapted to be received in a large width part of the tongue channel 19′ in the preassembled state shown in FIG. 1.

Going from the tongue portion 11′ circumferentially in the direction towards the second end portion 3′ of the band 1′, the clamp 10′ has a combined arrangement of the connecting or load retaining hook 20′ and the first tensioning hook 30′. The connecting hook 20′ has a central cut-out window 22′ and a free edge portion 21′ forming the radially outermost tip end of the hook 20′ for engagement in the aperture 42′ of the second tensioning hook 40′. The edge portion 21′ points in the circumferential direction towards the second end portion 3′ so that it hooks into the aperture 42′ when the two band ends 2A′ and 3A′ are under material deformation stress which pulls them circumferentially away from each other in the closed state of the clamp 10′. The connecting hook 20′ further has, in the circumferential direction opposite to the window 22′, a back surface which has a smooth radial slope and provides a ramp portion 23′ for the outermost end 3A′ of the second end portion 3′ during the closing operation of the clamp 10′.

The first and second tensioning hooks 30′, 40′ are both provided with tooth-like projections 31′, 41′ facing away from each other in the circumferential direction in FIG. 1. These tooth-like projections 31′, 41′ allow for forming an anti-slip form fit with the jaws of pliers (not shown) engaging with the first and second tensioning hooks 30′, 40′ in a closing operation of the clamp 10′.

The clamp 10′ is further provided with a tolerance compensating element in form of a wave 18′ at the second end portion 3′. The curved radial shape of the tolerance compensating wave 18′ allows for compensation of certain diameter variations in the clamp 10′ and the object to be fastened.

As can be seen best in the enlarged views of region X in FIGS. 3A and 3B, the upper free end 3A′ may have a raised central portion which facilitates the correct sliding of the free end 3A′ on the ramp portion 23′ of the connecting hook 20′ at the start of the closing action. However, the portion directly adjacent to the aperture 42′ is not raised and has a flat surface 43′.

Such a flat surface 43′ has a negative impact on the band alignment during the closing stroke, in particular at the end thereof, when the closing stress exerted onto the lower and upper band end portions 2′, 3′ is maximum. At this stage, the upper band portion 3′ slides on the connecting hook 20′ only with its flat surface 43′ having just a straight-line contact with the slope surface of the ramp portion 23′. This may potentially lead to misalignment in that the flat surface 43′ is tilted in the axial direction so that it is no longer circumferentially parallel to the ramp portion 23′.

The present invention solves this problem, in accordance with the first embodiment, by making the upper contact surface 45 non-flat, in particular rounded as shown in FIGS. 5A and 5B which are cross-sectional views taken in the axial plane. FIG. 4 shows a sectional view (taken in the radial plane) during the most critical end phase of the closing stroke. At this end phase, the jaws of a plier (not shown) act on the tooth-like projections 31, 41 of the first and second tensioning hooks 30, 40 to pull them together. At the stage shown in FIG. 4, the radial inner surface 45 of the upper band end 3 slides on the radial outer surface 25 of the topmost part of the ramp portion 23 of the connecting hook 20.

As can be best understood from FIG. 5A, any angular displacement of the relative positioning of the two contact surfaces 25, 45 in the axial direction results in a counteracting alignment force which is geometrically induced due to the non-flat and in particular rounded complementary cross-sectional shapes of the two contact surfaces 25, 45. This results in a centering force acting on the lower and upper band ends 2, 3 which helps to ensure self-alignment during the most critical final stage of the band closing action.

FIG. 5B show another view of the upper band end with the non-flat contact surface 45 along with an enlarged view of the encircled part C. The roundness is formed with a relatively large radius of curvature to benefit from the centering effect across the complete width of the contact surfaces 25, 45. Since band regions axially adjacent to the second contact surface 45 are raised to the same radial level as the raised band end 3A, the upward curved contact surface 45 axially ends in two lowermost rim parts 46A, 46B.

A second embodiment will now be explained with reference to FIGS. 6A-6C. According to this modification, the connecting hook 20 is provided with additional guiding elements 26A, 26B which are positioned axially adjacent to the ramp portion 23. Such guiding elements 26A, 26B are formed as radial protrusions to the left and right of the root part of the ramp portion 23 such that two funnel-like grooves 27A, 27B are provided between the root part of the ramp portion 23 and each of the guiding elements 26A, 26B. Such funnel-like grooves 27A, 27B are arranged for engaging with lower rim parts 46A, 46B of the contact surface 45 at an intermediate term of the closing action, i.e., the beginning of the end phase of the closing stroke when the contact surface 45 is about to slide on the root part of the ramp portion 23.

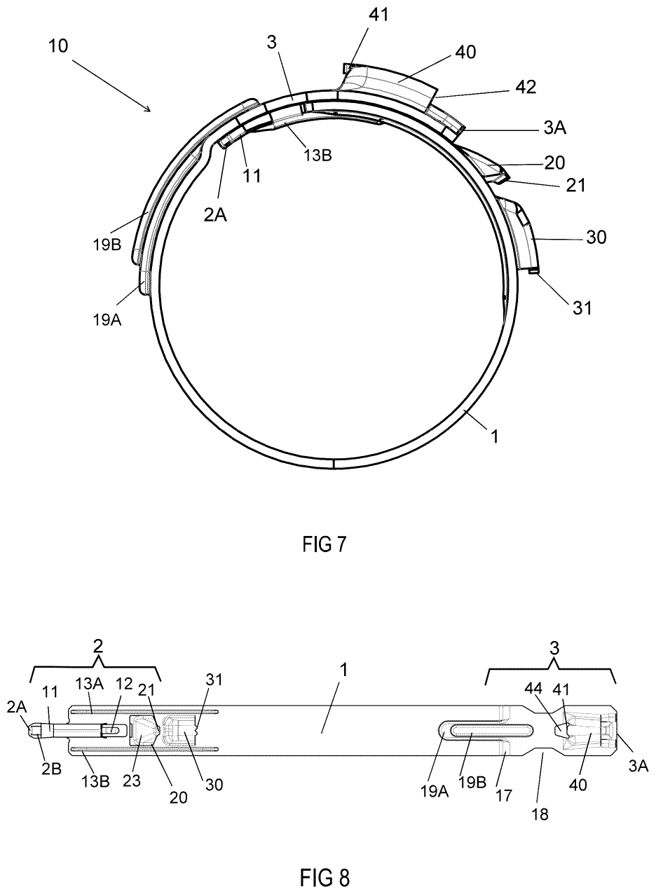

In the following, the overall clamp design of the first embodiment will be described with reference to FIGS. 7 and 8. FIG. 7 is a side view of the clamp 10 in a rounded and preassembled state. FIG. 8 shows the same clamp 10 in a flat (unrounded) state. The width W and the thickness t corresponding to the radial step 17 are the same as in the conventional design shown in present FIGS. 1 and 2.

The overall design and arrangement of the clamp 10 made from the flat metal band or strip 1 is quite similar to that of the prior art example shown in FIGS. 1 and 2. In particular, there is the tip end 2A of the first circumferential end portion 2 which has a reduced width and forms the tongue portion 11 adapted to be received in the tongue channel 19A at the inside of the second end portion 3 of the band 1. However, the tongue channel 19A is not formed by a cut-out of band material as the conventional channel 19′. Instead, the tongue channel 19A is closed and its “closed roof” has a groove 19B for receiving a protrusion 2B at the tip end 2A of the tongue portion 11. The closed design has better rigidity. Further, the preassembling hook 12 is formed at the root end of the tongue portion 11 and adapted to be received in the (closed) groove 19B in the preassembled state shown in FIG. 7. Side rails 13A, 13B for preventing band buckling are formed on both lateral sides of the root part of the tongue portion 11 and the hooks 20, 30.

As can be seen in FIG. 8, the connecting hook 20 has a free edge portion 21 serving as an engagement tooth which is adapted to be received in the aperture 42 of the second tensioning hook 40 in a closed state of the clamp 10. The connecting hook 20 further has a back surface which has a smooth radial slope and provides a ramp portion 23 for the outermost end 3A of the second end portion 3 during the closing operation of the clamp 10.

The first and second tensioning hooks 30, 40 are both provided with tooth-like projections 31, 41 which allow for forming an anti-slip form fit with the jaws of pliers (not shown) engaging with the first and second tensioning hooks 30, 40 in a closing operation of the clamp 10. Unlike the prior art example shown in FIGS. 1-3, the second tensioning hook 40 has a cut-out window 44 in the band material 1 adjacent to the tooth-like projection 41.

The clamp 10 is further provided with a reduced width part at the second end portion 3 in the band region between the radial step 17 and the second tensioning hook 40. This reduced width part serves as a tolerance compensating element 18 for compensation of certain diameter variations in the clamp 10 and the object to be fastened.

In summary, the present invention relates to a low profile clamp 10 in which one or both contact surfaces 25, 45 of upper and lower circumferential end portions 2, 3 have a non-flat and preferably complementary cross-sectional shape in the width direction of the band material 1. Thereby, sliding contact of the upper contact surface 45 on the lower contact surface 25 provides a self-centering effect of the band end portions 2, 3 during a band closing action.

List of Reference Signs

| | |
|---|---|
| 1, 1′ | flat band material |
| 2, 2′ | first end portion |
| 2A, 2A′ | first (inner) band end |
| 2B | protrusion |
| 3, 3′ | second end portion |
| 3A, 3A′ | second (outer) band end/free end |
| 10, 10′ | clamp |
| 11, 11′ | tongue portion |
| 12, 12′ | preassembling hook |
| 13A, 13B | side rails |
| 17, 17′ | step |
| 18, 18′ | tolerance compensation element |
| 19A, 19′ | tongue channel |
| 19B | groove |
| 20, 20′ | connecting hook (load retaining hook) |
| 21, 21′ | edge portion |
| 22′ | cut-out window |
| 23, 23′ | ramp portion |
| 25 | first contact surface |
| 26A, 26B | guiding elements |
| 27A, 27B | funnel-like grooves |
| 30, 30′ | first tensioning hook |
| 31, 31′ | first tooth-like protrusion |
| 40, 40′ | second tensioning hook |
| 41, 41′ | second tooth-like protrusion |
| 42, 42′ | aperture |
| 43′ | flat surface |
| 44 | cut-out window |
| 45 | second contact surface |
| 46A, 46B | lower rim parts of second contact surface |
| W | width of band material |
| t | thickness of band material |

What is claimed is:

1. A clamp made of a clamping band having first and second circumferential end portions which overlap one another in a closed condition of the clamp, the clamp comprising
a connecting hook protruding radially outwards at the first end portion,
a first tensioning hook protruding radially outwards at the first end portion, and
a second tensioning hook protruding radially outwards at the second end portion and having an aperture arranged for receiving an edge portion of the connecting hook when the clamp is brought into the closed condition by pulling the first and second tensioning hooks towards each other in a band closing action,
wherein the connecting hook has a first contact surface arranged for sliding contact during the band closing action with a second contact surface provided at the second end portion circumferentially adjacent to the aperture of the second tensioning hook,
characterized in that the second contact surface has a non-flat cross section in a width direction of the band material.

2. The clamp of claim 1, wherein the first contact surface has a non-flat cross section.

3. The clamp of claim 2, wherein the cross section of the first contact surface is formed complementary to the cross section of the second contact surface.

4. The clamp of claim 1, wherein the cross section of the second contact surface has a round shape.

5. The clamp of claim 4, wherein the cross section of the second contact surface has the shape of a ring segment.

6. The clamp of claim 1, wherein the non-flat cross section of the second contact surface extends up to the area immediately adjacent to the aperture side of the second tensioning hook.

7. The clamp of claim 1, wherein the second end portion has a free end which is radially raised, and the second contact surface is provided in a region which is circumferentially between the aperture of the second tensioning hook and the radially raised free end.

8. The clamp of claim 7, wherein the regions immediately adjacent to the second contact surface in the width direction of the band are at the same radial height as the raised free end and circumferentially extend at this height up to the raised free end.

9. The clamp of claim 1, wherein the first and second contact surfaces are provided only in a central part of the clamp band in the width direction.

10. The clamp of claim 1, wherein the connecting hook has a central ramp portion with the first contact surface at its radial outer portion.

11. The clamp of claim 10, wherein the connecting hook has, adjacent to the central ramp portion in the width direction, one or more guiding elements for centering the second end portion during the closing action.

12. The clamp of claim 11, wherein the one or more guiding elements provide one or more funnel-like grooves between the root of the ramp portion and the guiding elements, the one or more funnel-like grooves being arranged for engagement with one or more lower rim parts of the second contact surface during a midterm stage of the closing action.
